(19) United States
(12) Patent Application Publication
(10) Pub. No.: US 2018/0359486 A1
(43) Pub. Date: Dec. 13, 2018

(54) NON-LOCAL ADAPTIVE LOOP FILTER PROCESSING

(71) Applicant: MEDIATEK INC., Hsin-Chu City (TW)

(72) Inventors: Chen-Yen LAI, Hsinchu (TW); Ching-Yeh CHEN, Hsinchu (TW); Yu-Wen HUANG, Hsinchu (TW)

(73) Assignee: MEDIATEK INC., Hsin-Chu City (TW)

(21) Appl. No.: 16/001,599

(22) Filed: Jun. 6, 2018

Related U.S. Application Data
(60) Provisional application No. 62/516,152, filed on Jun. 7, 2017.

(51) Int. Cl. H04N 19/56; H04N 19/105; H04N 19/36; H04N 19/132; H04N 19/88; H04N 19/186

(52) U.S. Cl. CPC H04N 19/56; H04N 19/105; H04N 19/186; H04N 19/132; H04N 19/88; H04N 19/36

(57) ABSTRACT

Aspects of the disclosure provide a method for forming patch groups. The method can include determining a list of K motion vectors (MVs) for each current patch to form a patch group that includes the respective current patch and K reference patches corresponding to the K MVs, wherein the current patches are included in a reconstructed picture. The list of K MVs of a first current patch that is one of the current patches is determined by performing a neighbor-based fast search (NBFS) process. The NBFS process can include selecting K MVs from lists of K MVs of at least one neighboring current patch of the first patch to form a first list of K MVs of the first current patch, and performing a first refinement process to obtain a second list of K MVs of the first current patch based on the first list of K MVs.

### INCORPORATION BY REFERENCE

This present disclosure claims the benefit of U.S. Provisional Application No. 62/516,152, “Improved Non-local Adaptive Loop Filters (NLALF) with Multiple Fusions and Searching in Parallel”, filed on Jun. 7, 2017, which is incorporated herein by reference in its entirety.

### TECHNICAL FIELD

The present disclosure relates to video coding techniques.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Block-based motion compensation, transform, and quantization are broadly employed for video compression to improve performance of video communication systems. However, due to coarse quantization and motion compensation, compression noise can be introduced which causes artifacts, such as blocking, ringing, and blurring in reconstructed pictures. In-loop filters can be employed to reduce the compression noise, which can not only improve quality of decoded pictures, but also provide high quality reference pictures for succeeding pictures to save coding bits. A non-local adaptive loop filter is one type of such in-loop filter.

### SUMMARY

Aspects of the disclosure provide a method for forming patch groups. The method can include determining a list of K motion vectors (MVs) for each current patch to form a patch group for the respective current patch that includes the respective current patch and K reference patches corresponding to the K MVs, wherein the current patches are included in a reconstructed picture. The list of K MVs of a first current patch that is one of the current patches is determined by performing a neighbor-based fast search (NBFS) process. The NBFS process can include selecting K MVs from lists of K MVs of at least one neighboring current patch of the first patch to form a first list of K MVs of the first current patch, and performing a first refinement process to obtain a second list of K MVs of the first current patch based on the first list of K MVs.

In an embodiment, a first refinement range of the first N MVs on the first list of K MVs is larger than a second refinement range of the last K-N MVs on the first list of K MVs during the first refinement process. In an embodiment, the NBFS process further comprises before performing the first refinement process, replacing a portion of the first list of K MVs with a set of predefined MVs to increase a diversity of the first list of K MVs.

In an embodiment, the method can further include scaling a determined list of K MVs of one of the current patches of luma component to obtain a list of scaled K MVs of the respective current patch of chroma component, replacing a portion of the list of scaled K MVs with a set of predefined MVs to increase a diversity of the list of scaled K MVs to obtain a second list of scaled K MVs, and performing a refinement process based on the second list of scaled K MVs.

In an embodiment, the method can further include performing a scaling process to scale a determined list of K MVs of one of the current patches of luma component to obtain a list of scaled K MVs of the respective current patch of chroma component. A repeated scaled MV on the list of scaled K MVs is replaced with a MV having a predefined offset with respect to the repeated scaled MV to increase a diversity of the list of scaled K MVs.

In an embodiment, the method can further include partitioning the reconstructed picture into control blocks each including a subset of the current patches, and processing the control blocks in parallel to determine the lists of K MVs for the current patches to form the patch groups with a hybrid MV searching (HMVS) process that is performed on each control block, wherein the subset of current patches of a first control block is included in a first group of current patches and a second group of current patches. The HMVS process can include processing each current patch of the first group with a multi-subsample search pattern based search (MSPS) process, and processing each current patch of the second group with the NBFS process based on results of the first group.

In an embodiment, the current patches in the first control block are arranged in rows and columns, the top-left current patch in the first control block is included in the first group, and the remaining current patches in the first control block are included in the second group. The processing each current patch of the second group with the NBFS process can include sequentially processing the current patches of the second group in a raster scan order with the NBFS process. The at least one neighboring current patch includes a left patch for the current patches in the first row, a top patch for the current patches in the first column, and a top, left, and top-left patches for the other current patches of the second group.

In an embodiment, the current patches in the first control block are arranged in rows and columns, and the first group includes one of: the current patches in the first row, the first column, or the first row and the first column of the control block; the odd or even number of current patches in the first row and the first column of the control block; the current patches on an diagonal of the control block; or the current patches that interleave with the current patches of the second group forming a chessboard pattern.

In an embodiment, the processing each current patch of the first group with the MSPS process includes processing the current patches of the first group in parallel. In an embodiment, the current patches in the first control block are arranged in rows and columns, and the current patches of the first and second groups interleave with each other forming a chessboard pattern. For each current patch of the second group, the at least one neighboring current patch is the current patches of the first group neighboring the respective current patch of the second group. In one example, the processing each current patch of the second group with the NBFS process comprises processing the current patches of the second group in parallel.

In an embodiment, the current patches in the first control block are arranged in rows and columns, and the current patches of the first and second groups interleave with each other forming a chessboard pattern. For each current patch of the second group, the at least one neighboring current patch includes the current patches of the first group neighboring the respective current patch of the second group, and the current patches of the second group neighboring the respective current patch of the second group that are previously processed.

In an embodiment, a refinement process of the MSPS process or the first refinement process of the NBFS process includes sequentially processing an original list of K MVs of a second current patch to obtain a refined list of K MVs, wherein MVs in refinement ranges of the K MVs on the original list are investigated to select the K MVs on the refined list. When it is determined that a being processed MV on the original list has a distortion with respect to the second current patch that is greater than that of a worst MV of K MVs on the refined list, and a difference between the two respective distortions are larger than a threshold, terminating the respective refinement process.

In an embodiment, weighted pixel values are aggregated to obtain accumulated pixel values of a current patch or a reference patch of one of the patch groups. One of the weighted pixel values is ignored when a respective weight factor is smaller than a threshold.

Aspects of the disclosure provide a second method. The second method can include performing multiple rounds of a denoising process based on a MSPS process to test multiple search ranges, wherein current patches are included in a reconstructed picture. Each round of the denoising process includes determining a list of K MVs for each current patch to form respective patch groups by performing the MSPS process with one of the multiple search ranges, and denoising the patch groups to modify pixel values of the patch groups to create a denoised picture including a luma component and/or a chroma component. The second method further includes evaluating qualities of the created denoised pictures corresponding to different search ranges, and selecting a search range with a best quality of the denoised pictures from the multiple search ranges based on the evaluation.

Embodiments of the second method can include transmitting an indicator indicating the selected search range. In an embodiment, the evaluating the qualities of the denoised pictures corresponding to different search ranges comprises one of: comparing distortions of the denoised pictures corresponding to luma component, chroma component, or a summation of luma and chroma components, the distortions of the denoised pictures calculated with respect to a respective original picture; comparing the distortions of the denoised pictures corresponding to luma component, chroma component, or a summation of luma and chroma components, each of the compared distortions multiplied with a ratio corresponding to the respective search range, wherein the larger the respective search range, the larger the ratio; comparing the distortions of the denoised pictures corresponding to luma component, chroma component, or a summation of luma and chroma components, each of the compared distortions added with a bias corresponding to the respective search range, wherein the larger the respective search range, the larger the bias.

Aspects of the disclosure provide a third method. The third method can include providing a region including current patches included in a reconstructed picture, obtaining region-based information of the region, and performing an adaptive searching operation that is a first multi-subsample search pattern based search (MSPS) process adapted according to the region-based information of the region.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an encoder according to an embodiment of the disclosure;

FIG. 2 shows a decoder according to an embodiment of the disclosure;

FIG. 3 shows an example process for denoising a reconstructed picture according to an embodiment of the disclosure;

FIG. 4 shows an exemplary denoising process according to an embodiment of the disclosure;

FIG. 5 shows a search pattern according to an embodiment of the disclosure;

FIG. 6 shows an example multi-subsample search pattern based search (MSPS) process according to embodiments of the disclosure;

FIG. 7 shows a control block for illustrating a basic neighbor-based fast search (NBFS) process;

FIG. 8 shows the basic NBFS process according to an embodiment of the disclosure;

FIG. 9 shows an example of replacing candidate motion vectors (MVs) on the first list with larger MVs according to an embodiment of the disclosure;

FIGS. 10A-10D show some hybrid motion vector searching (HMVS) examples according to some embodiments of the disclosure;

FIG. 11 shows an example process implementing an HMVS method according to an embodiment of the disclosure;

FIG. 12 shows an example of a refinement early termination technique according to an embodiment; and

FIG. 13 shows a control block that is partitioned into four small regions.

### DETAILED DESCRIPTION OF EMBODIMENTS

### I. Non-Local Adaptive Loop Filter

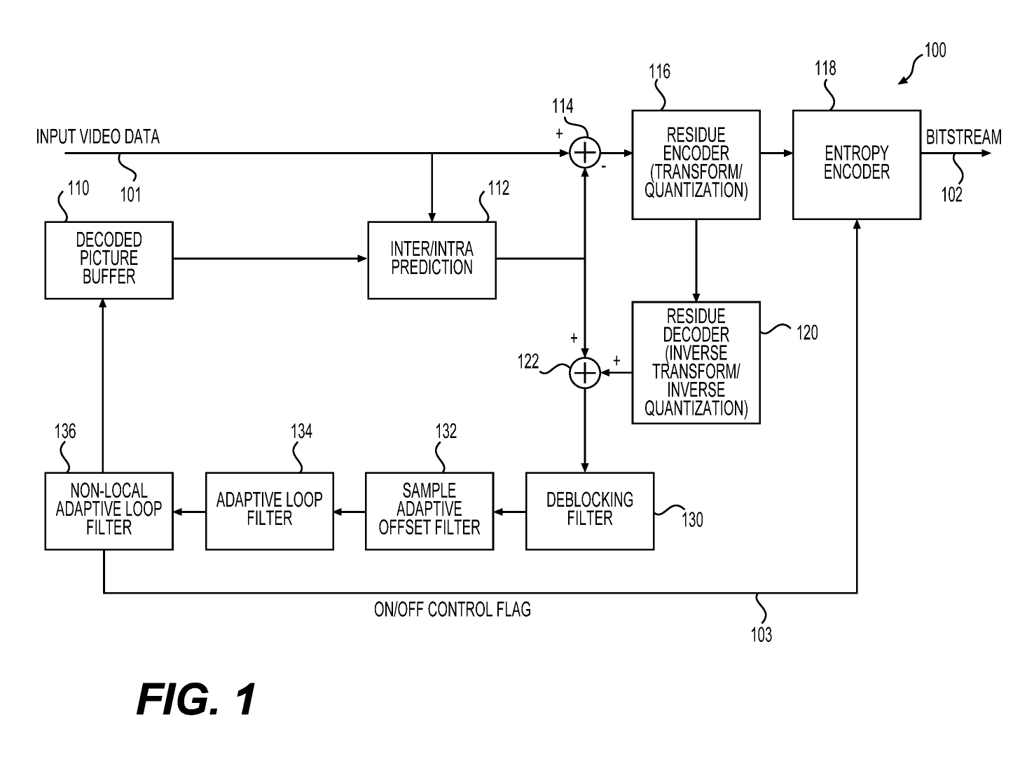

FIG. 1 shows an encoder 100 according to an embodiment of the disclosure. The encoder 100 can include a decoded picture buffer 110, an inter-intra prediction module 112, a first adder 114, a residue encoder 116, an entropy encoder 118, a residue decoder 120, a second adder 122, and one or more in-loop filters, such as a deblocking filter (DF) 130, a sample adaptive offset filter (SAO) 132, an adaptive loop filter (ALF) 134, and a non-local adaptive loop filter (NL-ALF) 136. Those components can be coupled together as shown in FIG. 1.

The encoder 100 receives input video data 101 and performs a video compression process to generate a bitstream 102 as an output. The input video data 101 can include a sequence of pictures. Each picture can include one or more color components, such as a luma component or a chroma component. The bitstream 102 can have a format compliant with a video coding standard, such as the Advanced Video Coding (AVC) standards, High Efficiency Video Coding (HEVC) standards, and the like.

In various embodiments, the NL-ALF 136 can employ non-local denoising techniques to improve the performance of the encoder 100. For example, the NL-ALF 136 can divide a reconstructed picture into a plurality of patches (referred to as current patches). For each current patch, the NL-ALF 136 searches for similar patches (referred to as reference patches) in the reconstructed picture to form a patch group. Subsequently, the NL-ALF 136 can apply a denoising technology to each patch group to modify pixel values of one or more patches in a respective patch group to reduce compression noise in those patches. The modified pixel values are returned to the picture to form a filtered picture.

In addition, it cannot be guaranteed that a processed pixel in the filtered picture is better in terms of noise level than a corresponding unfiltered pixel in the reconstructed picture. Accordingly, the NL-ALF 136 can adaptively determine for different blocks (or regions) in the picture whether a block would adopt the processed pixel values or retain the unfiltered pixel values of the reconstructed video data. Such a block can be referred to as a control block or a control unit. An on/off control flag can be employed for signaling the adaptive adoption of the processed pixel values in a respective control block.

According to an aspect of the disclosure, a series of techniques can be employed to improve performance of the NL-ALF 136. For example, a hybrid motion vector (MV) searching method can be used to search for reference patches to form patch groups. The hybrid MV searching method combines a multi-subsample patterns search (MSPS) algorithm with a neighbor-based fast search (NBFS) algorithm. An adaptive search range mechanism can be used to test multiple search ranges of a MSPS process, and accordingly select a best search range for a picture region (e.g., a slice). An early termination technique can be used to terminate a refinement process of a candidate reference patch list. A second adaptive search range mechanism can be used to adaptively determine a search range of a MSPS process for different patches within a local region, such as a region partitioned from a control block. Those techniques can lower computational cost of forming patch groups, improving efficiency of the NL-ALF 136.

In FIG. 1, the decoded picture buffer 110 stores reference pictures for motion estimation and motion compensation performed at the inter-intra prediction module 112. The inter-intra prediction module 112 performs inter picture prediction or intra picture prediction to determine a prediction for a block of a current picture during the video compression process. A current picture refers to a picture in the input video data 101 that is being processed in the inter-intra prediction module 112. The current picture can be divided into multiple blocks with a same or different size for the inter or intra prediction operations.

In one example, the inter-intra prediction module 112 processes a block using either inter picture coding techniques or intra picture coding techniques. Accordingly, a block encoded using inter picture coding is referred to as an inter coded block, while a block encoded using intra picture coding is referred to as an intra coded block. The inter picture coding techniques use the reference pictures to obtain a prediction of a currently being processed block (referred to as a current block). For example, when encoding a current block with inter picture coding techniques, motion estimation can be performed to search for a matched region in the reference pictures. The matched region is used as a prediction of the current block. In contrast, the intra picture coding techniques employ neighboring pixels of a current block to generate a prediction of the current block. The neighboring pixels and the current block are within a same picture. The predictions of blocks are provided to the first and second adders 114 and 122.

The first adder 114 receives a prediction of a block from the inter-intra prediction module 112 and original pixels of the block from the input video data 101. The adder 114 then subtracts the prediction from the original pixel values of the block to obtain a residue of the block. The residue of the block is transmitted to the residue encoder 116.

The residue encoder 116 receives residues of blocks, and compresses the residues to generate compressed residues. For example, the residue encoder 116 may first apply a transform, such as a discrete cosine transform (DCT), discrete sine transform (DST), wavelet transform, and the like, to received residues corresponding to a transform block and generate transform coefficients of the transform block. Partition of a picture into transform blocks can be the same as or different from partition of the picture into prediction blocks for inter-intra prediction processing.

Subsequently, the residue encoder 116 can quantize the coefficients to compress the residues. The quantization can be controlled with a quantization parameter (QP). A QP indicates a step size for associating the transform coefficients with a finite set of steps. A larger QP value represents bigger steps that crudely approximate the transform such that most of signals in the transform block can be captured by fewer coefficients. In contrast, a smaller QP value can more accurately approximate the transform, however, at a cost of increased bit number for encoding the residues. Accordingly, a larger QP can induce more distortion or compression noise into a picture resulted from the video compression process. The compressed residues (quantized transform coefficients) are transmitted to the residue decoder 120 and the entropy encoder 118.

The residue decoder 120 receives the compressed residues and performs an inverse process of the quantization and transformation operations performed at the residue encoder 116 to reconstruct residues of a transform block. Due to the quantization operation, the reconstructed residues are similar to the original residues generated from the adder 114 but typically are not the same as the original version.

The second adder 122 receives predictions of blocks from the inter-intra prediction module 112 and reconstructed residues of transform blocks from the residue decoder 120. The second adder 122 subsequently combines the reconstructed residues with the received predictions corresponding to a same region in the picture to generate reconstructed video data. The reconstructed video data can then, for example, be transferred to the DF 130.

In one example, the DF 130 applies a set of low-pass filters to block boundaries to reduce blocking artifacts. The filters can be applied based on characteristics of reconstructed samples on both sides of block boundaries in a reconstructed picture as well as prediction parameters (coding modes or MVs) determined at the inter-intra prediction module 112. The deblocked reconstructed video data can then be provided to the SAO 132. In one example, the SAO 132 receives the deblocked reconstructed video data and categorizes pixels in the reconstructed video data into groups. The SAO 132 can then determine an intensity shift (offset value) for each group to compensate intensity shifts of each group. The shifted reconstructed video data can then be provided from the SAO 132 to the ALF 134. In one example, the ALF 134 is configured to apply a filter to reconstructed video data to reduce coding artifacts in the temporal domain. For example, the ALF 134 selects a filter from a set of filter candidates and applies the elected filter to a region of the reconstructed video data. In addition, the ALF 134 can be selectively turned on or off for each block of the reconstructed video data. The processed reconstructed video data can then be transmitted to the NL-ALF 136.

As described above, the NL-ALF 136 can process the received reconstructed video data using one or more non-local denoising techniques to reduce compression noise in the reconstructed video data. In addition, the NL-ALF 136 can determine whether the non-local adaptive filtering is applied for a control block in a denoised picture. For example, the NL-ALF 136 processes the received reconstructed video data and generates filtered video data. The NL-ALF 136 can then compare a filtered block of the filtered video data with a corresponding block of the received reconstructed video data to determine whether a distortion of the filtered block with respect to an original picture has been improved. When the distortion of the filtered block is improved, the pixel values of this filtered block can be adopted for forming the denoised picture. Otherwise, the pixel values of the corresponding block of the received reconstructed video data are adopted in the denoised picture. Accordingly, the denoised picture can be constructed based on the decision of whether to adopt filtered pixel values for a respective control block in the denoised picture. The denoised picture can then be stored to the decoded picture buffer 110.

An on/off control flag can be employed to signal the above decision for the respective control block to a decoder such that the decoder can process the control block in the same way. As shown in FIG. 1, on/off control flags 103 indicating whether non-local adaptive loop filtering is applied to respective control blocks are transmitted to the entropy encoder 118 in one example.

The entropy encoder 118 receives the compressed residues from the residue encoder 116 and on/off control flags 103 from the NL-ALF 136. The entropy encoder 118 may also receive other parameters and/or control information, such as intra prediction mode information, motion information, quantization parameters, and the like. The entropy encoder 118 encodes the received parameters or other information to form the bitstream 102. The bitstream 102 including data in a compressed format can be transmitted to a decoder via a communication network, or transmitted to a storage device (e.g., a non-transitory computer-readable medium) where video data carried by the bitstream 102 can be stored.

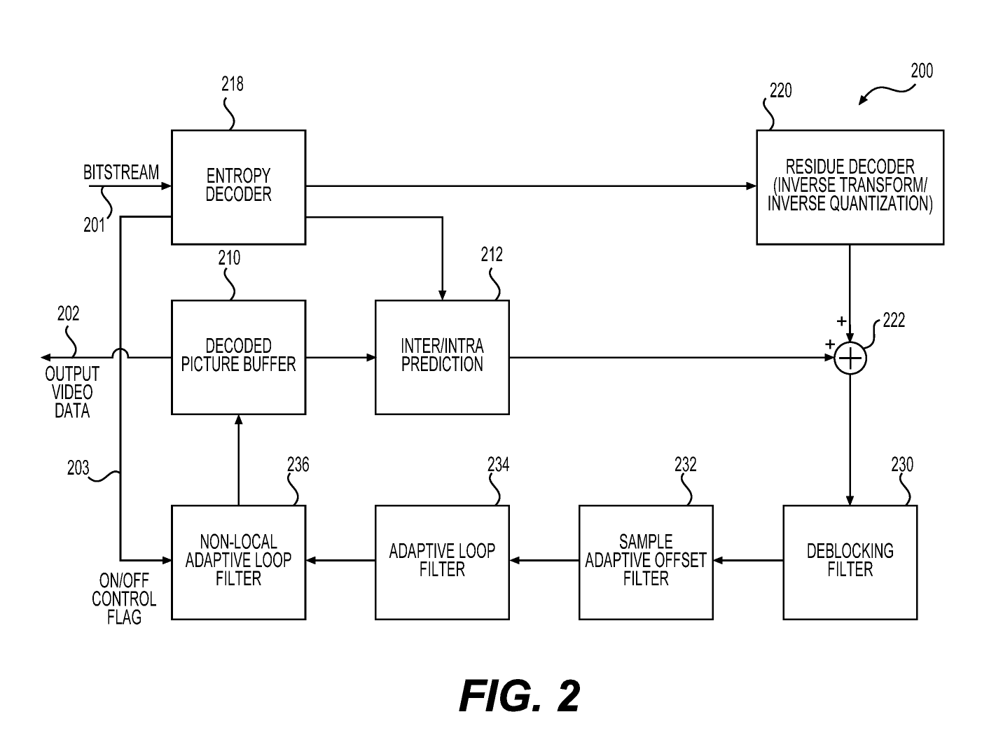

FIG. 2 shows a decoder 200 according to an embodiment of the disclosure. The decoder 200 includes an entropy decoder 218, a residue decoder 220, a decoded picture buffer 210, an inter-intra prediction module 212, an adder 222, and one or more in-loop filters, such as a DF 230, an SAO 232, an ALF 234, and a NL-ALF 236. Those components are coupled together as shown in FIG. 2. In one example, the decoder 200 receives a bitstream 201 generated by an encoder, such as the bitstream 102 generated by the encoder 100, and performs a decompression process to generate output video data 202. The output video data 202 can include a sequence of pictures that can be displayed, for example, on a display device, such as a monitor, a touch screen, and the like.

Similar to the encoder 100 in FIG. 1 example, the decoder 200 employs the NL-ALF 236, which has a similar function as the NL-ALF 136, to denoise a reconstructed picture to obtain a filtered picture. For example, the series of techniques, such as the hybrid MV searching method, the second adaptive search range mechanism, the early termination technique, can be employed to improve performance of the NL-ALF 236. However, different from the NL-ALF 136 in FIG. 1 example, the NL-ALF 236 receives on/off control flags 203 from the bitstream 201, and accordingly determines which blocks of pixel values in the filtered picture are to be included or excluded in a denoised picture. For example, when a control flag 203 of a control block is in a state of on, filtered pixel values of the control block in the filtered picture are adopted to the corresponding control block of the denoised picture, while when a control flag 203 of a control block is in a state of off, pixel values of the control block of the reconstructed picture are adopted.

The entropy decoder 218 receives the bitstream 201 and performs a decoding process which is an inverse process of the encoding process performed by the entropy encoder 118 in FIG. 1 example. As a result, compressed residues, prediction parameters, on/off control flags 203, and the like, are obtained. The compressed resides are provided to the residue decoder 220, and the prediction parameters are provided to the inter-intra prediction module 212. The inter-intra prediction module 212 generates predictions of blocks of a picture based on the received prediction parameters, and provides the predictions to the adder 222. The decoded picture buffer 210 stores reference pictures useful for motion compensation performed at the inter-intra prediction module 212. The reference pictures, for example, can be received from the NL-ALF 236. In addition, reference pictures are obtained from the decoded picture buffer 210 and included in the picture video data 202 for displaying to a display device.

The residue decoder 220, the adder 222, the DF 230, the SAO 232, and the ALF 234 are similar to the residue decoder 120, the second adder 122, the DF 130, the SAO 132, and the ALF 134 in terms of functions and structures. Description of those components is omitted.

The employment of a non-local adaptive loop filter, such as the NL-ALFs 136 and 236, in a decoder or encoder reduces a noise level in reconstructed video data, resulting in high quality output pictures. In addition, when those high quality pictures are used as reference pictures for encoding succeeding pictures, bit rate for transmission of the compressed pictures can be decreased. Therefore, denoising techniques disclosed herein for improving performance of a NL-ALF can improve performance and capability of a decoder or encoder which includes the NL-ALF.

While the FIG. 1 and FIG. 2 examples show a series of filters 130, 132, and 134, or 230, 232, and 234, that are included in the encoder 100 or decoder 200, it should be understood that none or fewer of such filters can be included in an encoder or decoder in other embodiments. In addition, the position of the NL-ALF 136 or 236 with respect to other filters can be different from what is shown in the FIG. 1 or FIG. 2 examples. For example, the NL-ALF 136 can be arranged in front of other filters so that it is directly coupled to the adder 122, or at the end of the series of filters, or among the series of filters.

In various embodiments, the NL-ALFs 136 and 236 can be implemented with hardware, software, or combination thereof. For example, the NL-ALF 136 or 236 can be implemented with one or more integrated circuits (ICs), such as an application specific integrated circuit (ASIC), field programmable gate array (FPGA), and the like. For another example, the NL-ALF 136 or 236 can be implemented as software or firmware including instructions stored in a computer readable non-volatile storage media. The instructions, when executed by a processing circuit, causing the processing circuit to perform functions of the NL-ALF 136 or 236.

It is noted that the NL-ALFs 136 and 236 implementing the denoising techniques disclosed herein can be included in other decoders or encoders that may have similar or different structures from what is shown in FIG. 1 or FIG. 2. In addition, the encoder 100 and decoder 200 can be included in a same device, or separate devices in various examples.

### II. Non-Local Denoising Technologies

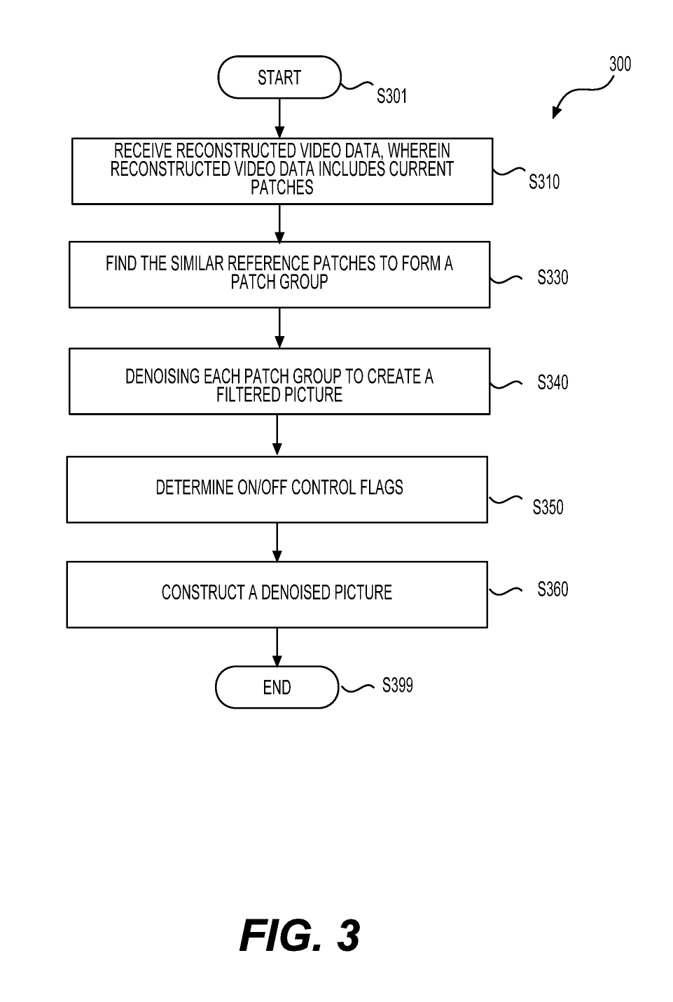

FIG. 3 shows an example process 300 for denoising a reconstructed picture according to an embodiment of the disclosure. The process 300 can be performed at the NL-ALF 136 or 236 in the FIG. 1 or FIG. 2 example, and the FIG. 1 example is used to explain the process 300.

The process 300 starts from S301 and proceeds to S310. At S310, reconstructed video data is received at the NL-ALF 136, wherein the received reconstructed video data (corresponding to the reconstructed picture) includes a plurality of patches. For example, the second adder 122 receives predictions from the inter-intra prediction module 122, and residues from the residue decoder 120, and combines the predictions and residues to generate reconstructed video data. In various embodiments of the process 300, the reconstructed video data can correspond to a picture, a frame, a slice of a picture, or a predefined region of a picture. Accordingly, a picture or a reconstructed picture corresponding to the reconstructed video data can refer to a picture, a frame, a slice of a picture, or a predefined region of a picture, and the like, in this disclosure.

In addition, a filtered picture, or a denoised picture resulting from a picture corresponding to reconstructed video data can accordingly refer to a picture, a frame, a slice of a picture, or a predefined region of a picture, and the like in this disclosure. Depending on a number of in-loop filters employed and a position of the NL-ALF 136 among those in-loop filters, the reconstructed video data can correspond to reconstructed video data generated from the residue decoder 120, or filtered reconstructed video data generated from a filter adjacent and previous to the NL-ALF 136.

In one example, the patches have a same size and shape, and are non-overlapped with each other. In other examples, the patches may have different sizes or shapes. In further examples, the patches may overlap with each other. Each patch includes a plurality of pixels, and is referred to as a current patch. In one example, a slice includes control blocks having a size of 32×32 pixels. The control blocks each further include 16 current patches having a size of 8×8 pixels.

At S330, for each current patch, a plurality of similar patches (referred to as reference patches) are found in the reconstructed picture, or in some examples, in a search window (a to-be-searched region) within the reconstructed picture. The reference patch can have a similar shape and size as the respective current patch. In addition, the reference patches can overlap each other, and the reference patches and the respective current patch can overlap each other.

Each current patch and the respective similar reference patches form a patch group. In one example, for each current patch, the K most similar (or nearest) patches are found, and the current patch and the respective K most similar patches form a patch group including K+1 patches. K indicates a number of similar patches corresponding to a current patch, and K can have different values for different current patches or patch groups in some examples. In one example, similar patches found for a respective current patch are not the most similar reference patches but reference patches having a similarity measure above a threshold. The similarity measure can be obtained based on a similarity metric. In one example, patch groups are formed for a portion of the current patches instead of for each current patch.

The K most similar reference patches can be represented by respective MVs directing to positions of the K most similar reference patches from a respective patch. Thus, a patch group forming process can be equivalent to a MV searching process in which K MVs corresponding to K most similar reference patches are determined. A list of K MVs can be obtained at a result of a patch group forming process.

In various embodiments, various search methods can be used to search for the K most similar (or nearest) reference patches for a respective current patch. In addition, in various embodiments, various similarity metrics can be used to measure the similarity between a current patch and a reference patch. For example, the similarity metric can be a sum of absolute differences (SAD), or a sum of square differences or errors (SSD or SSE), between corresponding pixel values in a current patch and a corresponding reference patch. For another example, pixel values in a current patch and a corresponding reference patch can be arranged as two vectors, and a L2 norm distance between those two vectors can be used as a similarity metric. A similarity is also referred to as a distortion. The terms similarity and distortion may be used interchangeably in this detailed description.

In some embodiments, forming patch groups of chroma component is performed in a way similar to forming patch groups of luma component. In alternative embodiments, patch groups of luma component are first formed. Then, results of the luma patch groups are reused for chroma component. For example, K MVs of a luma patch can be reused for chroma component to determine K most similar reference patches. Additionally, the K MVs of a luma patch may be processed with a vector scaling operation when the chroma and luma components have different pixel sampling rates.

At S340, a denoising technology is applied to each patch group to modify pixel values of one or more patches in the respective patch group. The modified pixel values of different patches either belonging to a same patch group or different patch groups are then aggregated to form a filtered picture, for example, by operations of weighted sum. In various embodiments, various denoising technologies can be employed to process the patch groups. For example, the denoising technology can be a non-local means (NLM) denoising technology, a block matching and 3D filtering (BM3D) denoising technology, or a low-rank approximation (LRA) denoising technology. However, the denoising technology applicable for processing the patch groups are not limited to the NLM, BM3D, or LRA technologies.

In addition, in some examples, more than one type of denoising technologies may be used in combination for processing patch groups. For example, different patch groups may have different statistic characteristics. Accordingly, different denoising technologies may be applied for different patch groups.

Further, filtered pictures can be obtained for luma and/or chroma component in various examples.

At S350, on/off control flags associated with a control block in a denoised picture are determined in a manner as described above. In addition, the determination can be based on luma component, chroma component, or a summation of luma and chroma component in the denoised picture.

The on/off control flags indicate whether the control block adopts filtered pixel values in the filtered picture or pixel values of the reconstructed picture corresponding to the received reconstructed video data. The on/off control flags can be signaled from an encoder to a decoder. That is, the encoder determines the values of the on/off control flags and incorporates the on/off control flags with the determined values in the bitstream, so that the decoder parses the on/off control flags from the bitstream to determine the values of the on/off control flags.

In various embodiments, control blocks for control of whether to adopt filtered pixel values resulting from the denoising operations at S340 can be defined or partitioned in various ways. For example, a partition of the control blocks can be consistent with a partition of coding units defined in the HEVC standard. Or, a partition of the control blocks can be consistent with a block partition used in a filter, such as the DF 130, the SAO 132, or the ALF 134, for purpose of control a filtering operation. Alternatively, the control block partition can be determined according to noise characteristics of different regions in a picture. In various examples, the control block partition information can be signaled from an encoder to a decoder, derived at a decoder, or predefined as a default configuration at both an encoder and a decoder.

At S360, the denoised picture are constructed based on the on/off control flag decisions. For control blocks associated with an on flag, filtered pixel values resulting from the denoising operation as S340 are adopted for the respective control blocks, while for control blocks associated with an off flag, pixel values of the received reconstructed picture are adopted for the respective control blocks. Subsequently, a reference picture can be generated based on the denoised picture. For example, the denoised picture can be stored to the decoded picture buffer 110 to be used as a reference picture. Alternatively, depending on the position of the NL-ALF 136 among other in-loop filters, the denoised picture may first be processed by other in-loop filters before storing into the decoded picture buffer 110. The process 300 proceeds to S399, and terminates at S399.

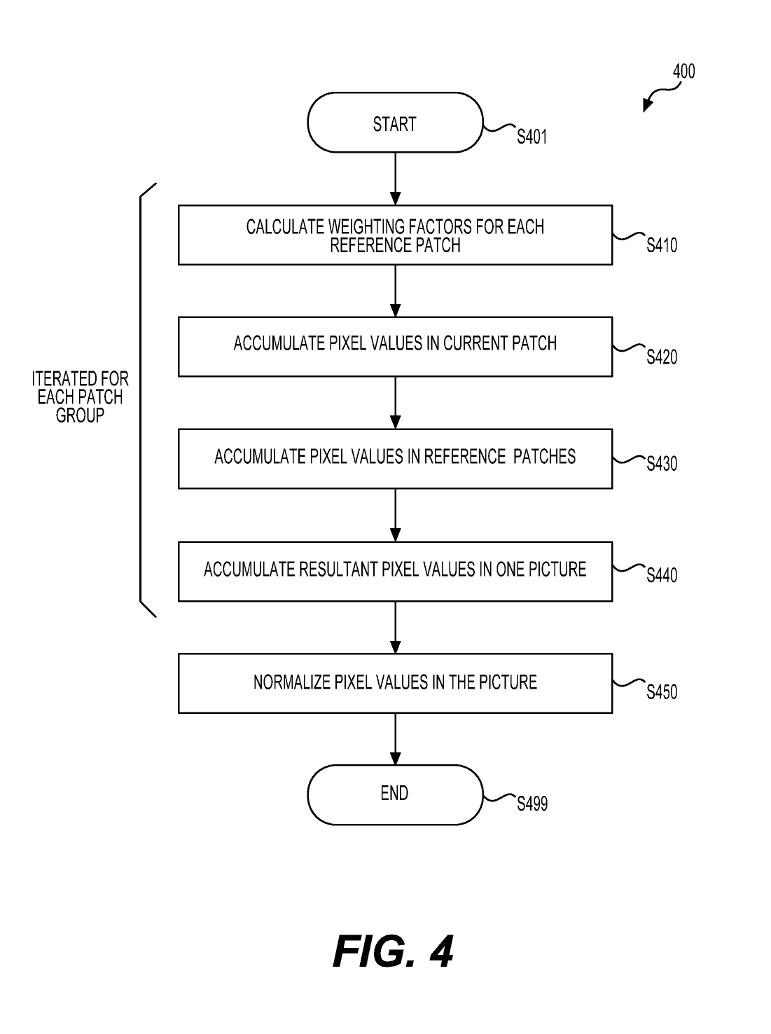

FIG. 4 shows an exemplary denoising process 400 according to an embodiment of the disclosure. The denoising process 400 employs a denoising technology that is one of the various denoising technologies employed at S340 in the process 300. Accordingly, the process 400 can be performed in place of S340 in the process 300 to obtain a denoised picture. Similarly, for other denoising technologies employed at S340, a process corresponding to the respective denoising technology can be performed in place of S340. The NL-ALF 136 is used as an example to explain the process 400.

The process 400 starts from S401 and proceeds to S410. Before initiation of the process 400, patch groups corresponding to reconstructed video data received at the NL-ALF 136 can have already been formed, for example, by performing the steps of S310-S330 in the process 300. The received reconstructed video data can correspond to a reconstructed picture or a portion of the reconstructed picture (such as a slice of the reconstructed picture). Assume the received reconstructed video data corresponds to a reconstructed picture below. The steps of S410-S440 are iterated for each patch group of the reconstructed picture. During the iteration, a patch group being processed in each round of the iteration is referred to as a current patch group.

At S410, weighting factors for each reference patch in a current patch group are calculated. The weighting factor of a reference patch can be calculated based on a similarity between the reference patch and a respective current patch in the current reference patch group. The more a reference patch is similar to the current patch, the larger the weighting factor of the reference patch. In one example, the weighting factors are determined using the following expression,

w_{i,j}=e^{-(ASSE/Var)}.

In the above expression, i and j are patch indexes, w_{i,j} represents a weighting factor of a reference patch j with respect to the respective current patch i; ASSE represents an average of a sum of square errors between corresponding pixel values in the patches i and j, and indicates the similarity degree between the patches i and j; Var can be defined as a variance of compression noise in the current patch group or a variance of compression noise in the current patch of the current patch group, and Var can be referred to as a noise variance.

The noise variance Var can be equal to a square of a standard deviation (SD) of compression noise of the current patch group when the definition of the noise variance Var is the variance of compression noise in the current patch group; or the noise variance Var can be equal to a square of a standard deviation (SD) of compression noise of the current patch when the definition of the noise variance Var is the variance of compression noise in the current patch of the current patch group. An SD of compression noise of a current patch group or the current patch can be further referred to as a noise SD of the respective patch group. A noise SD of a patch group indicates a noise level of the respective patch group. Thus, a noise SD of a patch group can be referred to as a noise level of the respective patch group. In addition, the noise variance Var can indicate strength of the filtering operation. The higher the compression noise level, the higher the Var, and the larger the corresponding weighting factors of the current patch group.

At S420, pixel values in the current patch are accumulated. In one example, the accumulation of the current patch pixel values is performed in a way that weighted pixel values of corresponding pixels in each reference patch are aggregated to corresponding pixel values of the current patch based on the respective weighting factors of each reference patch. In one example, the accumulation is performed according to the following expression,

x_{Ai}(p)=xᵢ(p)+Σⱼ₌₁^{K}w_{i,j}·yⱼ(p),

where p is a pixel index, x_{Ai}(p) represents an aggregated pixel value of the pixel, p, in the current patch i resulting from the aggregation, xᵢ(p) represents an original pixel value of the pixel, p, in the current patch i before the aggregation, yⱼ(p) represents an original pixel value of the pixel, p, in a reference patch j.

At S430, pixel values in each reference patch of the current patch group are accumulated. In one example, the accumulation of pixel values of a reference patch is performed in a way that a weighted pixel value of a corresponding pixel in the current patch are added to a corresponding pixel value of the reference patch based on the weighting factors of the reference patch. In a first example, the accumulation is performed according to the following expression,

y_{Aj}(p)=yⱼ(p)+w_{i,j}·x_{Ai}(p),

where p is a pixel index, y_{Aj}(p) represents an aggregated pixel value of the pixel, p, in a reference patch j resulting from the aggregation, x_{Ai}(p) represents the aggregated pixel value of the pixel, p, in the current patch i resulting from the aggregation at S420, yⱼ(p) represents an original pixel value of the pixel, p, in the reference patch j. In a second example, xᵢ(p) in the current patch i is used in the above accumulation instead of x_{Ai}(p).

At S440, the accumulated pixel values of the current patch and the reference patches resulting from S420 and S430 are accumulated to corresponding pixels in a picture, referred to as an accumulation picture. As the reference patches and the current patch in the current patch group can overlap each other, a pixel in the accumulation picture may receive pixel values from multiple patches, either the current patch or one or more reference patches. As the steps S410-S440 are performed for each patch group, accumulated pixel values of the respective current or reference patches of each round of the iteration can be accumulated to the accumulation picture at S440. Accordingly, a pixel in the accumulation picture can receive accumulated pixel values from one or multiple patch groups.

At S450, accumulated pixel values in the accumulation picture are normalized to obtain a filtered picture. As a result of S440, an accumulated pixel in the final accumulation picture can include multiple portions of pixel values, and each of the portions corresponds to an original pixel value of either a current patch or a reference patch multiplied by a gain. Each gain corresponds to a weighting factor, or a product of one or more weighting factors. Accordingly, an accumulated pixel in the accumulation picture can be divided by a sum of those gains to obtain a normalized pixel value. Those normalized pixel values form the filtered picture. The process 400 proceeds to S499 and terminates at S499.

As an example, after performance of the process 400, the steps of S350 and S360 in process 300 can be performed to the filtered picture to determine the on/off control flag and construct a denoised picture. Denoised pictures corresponding to luma component and/or chroma component may be obtained.

### III. Multi-Subsample Search Pattern (MSP) and Multi-Subsample Search Pattern Based Search (MSPS)

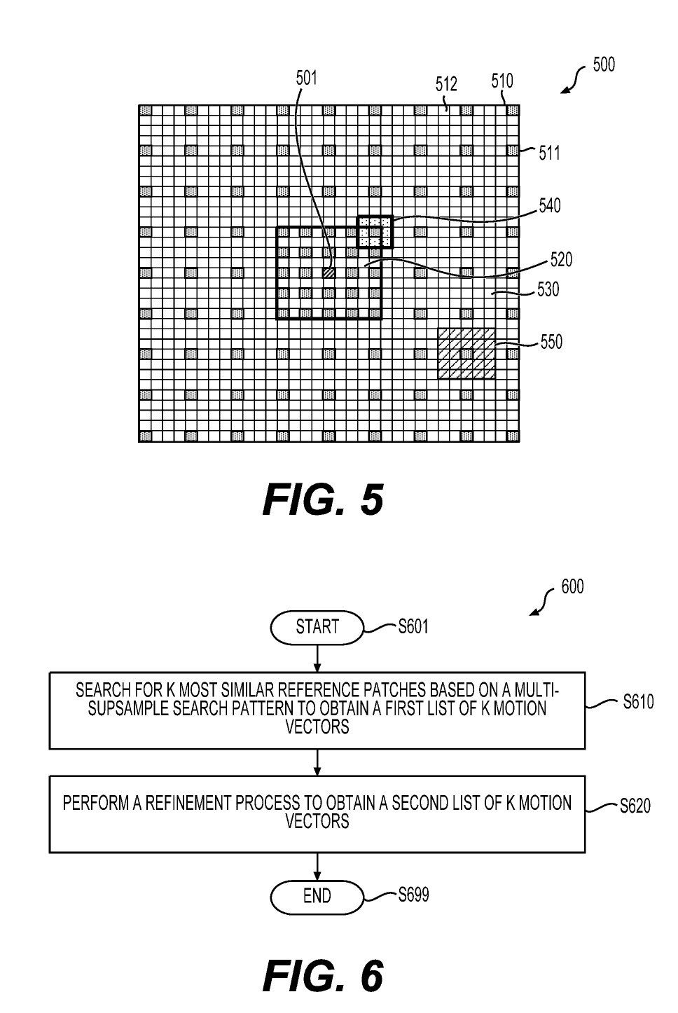

FIG. 5 shows a search pattern 500 according to an embodiment of the disclosure. The search pattern 500 can be used for the reference patch or MV searching as described in the process 300 in FIG. 3 example. The search pattern 500 includes a plurality of candidate positions (shaded cells) 511 in a search grid 510. The search grid 510 is a search window defined over a reconstructed picture or slice, and each cell 512 in the search grid 510 can correspond to a pixel in the reconstructed picture or slice. The search grid 510 can be centered on a position 501 of a current patch, and the K reference patches or MVs of the current patch at the position 501 can be selected from the candidate positions 511.

In the FIG. 5 example, the search pattern 500 has a shape of a square, and has a search range of [−16, 16] with respect to the central position 501 on the search grid 510. In an alternative example, a search window may have a different shape (other than a square), a search range may be defined or represented differently. However, in general, a search range corresponding to a search pattern defines a size of the respective search window.

The search grid 510 is partitioned into two sub-regions 520 and 530. The first sub-region 520 has a range of [−4, 4]. The second sub-region 530 is the remaining area of the search grid 510. The two sub-regions 520 and 530 have two different candidate position subsample ratios, 1/2 and 1/16, respectively. A candidate position subsample ratio of a search region can be a ratio of a number of candidate positions to a number of cells in the search region. Thus, the search pattern 500 is referred to as a multi-subsample search pattern (MSP). A reference patch search process performed on a MSP can be referred to as a multi-subsample search pattern based search (MSPS).

In alternative examples, MSPs can be defined differently compared with the search pattern 500. For example, a MSP can have a different search range (a different size), a different shape (e.g., rectangular instead of square), a different partition of sub-regions (e.g. more than two sub-regions, or sub-regions with a different shape), different subsample ratios corresponding to different sub-regions.

FIG. 6 shows an example MSPS process 600 according to embodiments of the disclosure. The MSPS process 600 can be performed to determine K most similar reference patches or MVs of a current patch. The process 600 can start from S601, and proceeds to S610.

At S610, searching for the K most similar reference patches or MVs of a current patch can be performed based on a MSP, such as the search pattern 500. The searching can be initiated with one of the plurality candidate positions 511, and traverse other candidate positions 511 subsequently in any order. A list of MVs corresponding to K selected candidate reference patches can be maintained during the search. MVs on the list can be arranged in a descending order according to similarities of reference patches corresponding to the MVs on the list (the most similar one is at the front of the list). Each MV represents a candidate position 511 corresponding to a selected candidate reference patch.

During the search, the candidate positions 511 are investigated one by one in one example. When a reference patch at a candidate position 511 has a better similarity than a member of the MV list, a MV of this reference patch is added to the list of K MVs. As a result of S610, K most similar reference patches can be selected from the candidate positions of the pattern 500, and a first list of K MVs corresponding to the K selected reference patches can be obtained.

At S620, a refinement process can be performed based on the first list of K MVs that is used as an initial set of MVs for the refinement process. For example, for each member of the first list, positions within a refinement range surrounding a position of the respective reference patch on the first list can be investigated. When a reference patch having a better similarity than a member of the first list is found, this reference patch is added to the first list. A worst (last) reference patch can be removed from the first list. In this way, a second list of K most vectors can be determined based on searching the refinement ranges corresponding to members of the first list.

As shown in FIG. 5, a first refinement range 540 can be defined for MVs of the first list directing at the first sub-region 520, and can have a size of [−1, 1]. A second refinement range 550 of [−2, 2] can be defined for MVs of the first list directing at the second sub-region 530. Each refinement range can be centered at each of the positions corresponding to MVs on the first list. In various examples, different refinement ranges can be defined. The process 600 can proceed to S699, terminate at S699.

As an example, a patch group forming process based on the MSPS process 600 for processing a reconstructed picture can be performed in the following way. First, a reconstructed picture (or slice) can be partitioned into multiple control blocks. The control blocks can be partitioned into current patches. For luma component, each control block can have a size of 32×32 pixels, and can include 16 current patches each have a size of 8×8 pixels. For chroma component, each control block can include patches in a similar way. Each chroma current patch can correspond to a luma current patch, and may include a same or different number of pixels depending on respective video format.

Second, the luma component can be processed based on the MSPS process 600. For example, for each luma current patch, the MSPS process 600 can be performed based on a search pattern to determine a refined list of K MVs. Accordingly, patch groups can be formed for each luma current patch.

Third, the chroma component can be processed. For example, a MV list of a luma current patch can be reused for a corresponding chroma current patch without performing a search process or a refinement process. In some examples, an additional scaling process is applied to scaling the luma MVs when the luma and chroma components have different sampling rates. For example, corresponding to a video format of YUV 420, luma MVs may be scaled by 50%.

### IV. Neighbor-Based Fast Search (NBFS) for MV Searching

IV-1. Basic NBFS

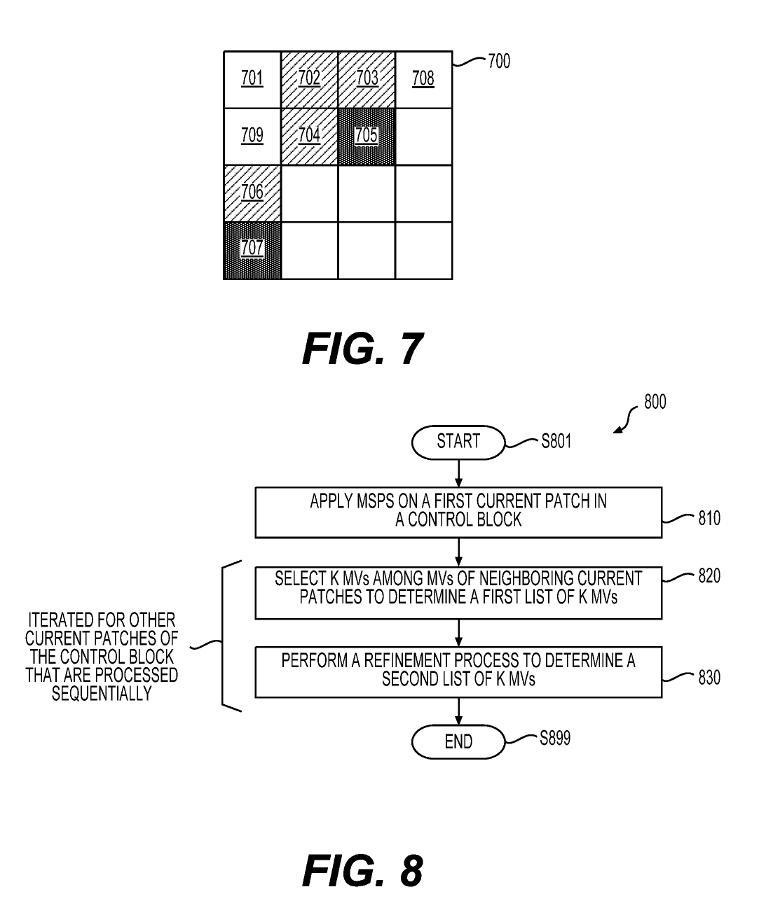

FIG. 7 shows a control block 700 for illustrating a basic NBFS process 800. FIG. 8 shows the basic NBFS process 800 according to an embodiment of the disclosure. The control block 700, for example, can have a size of 32×32 pixels, and includes 16 current patches of a size of 8×8 pixels, such as the current patches 701-709 in FIG. 7.

The basic NBFS process 800 can be a predictor-based search algorithm. In the basic NBFS process, the K MVs corresponding to K most similar reference patches of a current patch can be selected from list(s) of K MVs of neighboring current patch(es). The list(s) of K MVs can have been determined previously, and used as predictors to determine a list of K MVs of the current patch being processed. The process 800 can start from S801, and proceeds to S810.

At S810, a MSPS, such as the MSPS process 600, can be applied to a first current patch 701 located at the top-left corner of the control block 700. As a result, a list of K MVs of the first current patch 701 can be obtained.

Then, S820 and S830 are iterated for other current patches of the control block 700. The other current patches of the control block 700 can be processed sequentially, for example, in a raster scan order (row by row, from left to right). As a result, a refined list of K MVs corresponding to K most similar reference patches can be determined for each of the other current patches of the control block 700.

At S820, K MVs can be selected among MVs of each neighboring current patch to determine a first list of K MVs of a current patch being processed. For example, the neighboring current patches can be on the top, left, and/or top-left of the current patch being processed, and have already being processed. For example, for the current patch 705, the K MVs can be determined based on MVs of the three neighboring patches 702-704 that are previously determined. For example, reference patches corresponding to determined MVs of the patches 702-704 can be investigated one by one, and K best reference patches can thus be determined. MVs of the K best reference patches can be included in the first list of K MVs.

For the current patch 707, in one example, the top patch 706 of the current patch 707 is used to determine the first list of K MVs of the patch 707. Similarly, for a current patch in the first row, such as the current patch 703, the left patch 702 of the current patch 703 is used to determine the first list of K MVs of the patch 703.

While in the above examples MVs of left, top, and/or top-left neighboring patches are used as predictors for determining a first list of K MVs, in alternative examples, current patches other than the left, top, or top-left neighboring patches may be employed. For example, the patches 701, 708, and/or 709 may be considered in addition to the patches 702-703 for providing a set of MV predictors for processing the current patch 705 as far as respective predictor MVs are available.

At S830, a refinement process can be performed to determine a second list of K MVs corresponding to K most similar reference patches of the current patch being processed. The refinement process can be performed based on the first list of K MVs in a way similar to the S620 in the process 600. However, a refinement range may be different or the same as that used at S620. For example, the refinement range can be [−1, 1] with respect to a reference patch on the first list. The process 800 may proceed to S899, and terminates at S899.

In some examples, the above basic NBFS process 800 can first be used for processing control blocks of a luma component. Then, K MVs of luma current patches are reused at respective chroma current patches. MV scalings may be performed when appropriate. In some examples, the processing of chroma component may be included in the process 800 and become part of the process 800.

In the above examples, because only motion vectors of neighboring patches within a control block are used for deriving the list of K MVs, the NBFS method as described herein can support parallel processing on control blocks for forming patch groups.

In alternative examples, the NBFS method as described herein may be applied to reconstructed pictures where no control blocks are defined. For example, a predefined region may replace the control blocks in the process 800.

IV-2. NBFS with Increased Diversity

In the above basic NBFS process 800, candidate MVs of neighboring current patches may be too similar with each other, or in other words, the respective candidate reference patches may located close to each other at a small area. Candidate patches with a better similarity may be distributed outside the small area. Thus, the following techniques can be employed to introduce an additional diversity into the basic NBFS process 800.

IV-2-A. Enlarged Refinement Range

In an embodiment, the refinement range is enlarged at S830 for a subset of the first list of K MVs. For example, instead of the refinement range of [−1, 1], a larger refinement range can be used, such as [−2, 2], or [−3, 3], for the first N candidates (i.e., 1^{st} candidate, 2^{nd} candidate, . . . , Nth candidate) on the first list. In an embodiment, for chroma component processing, instead of directly reuse of scaled luma K MVs for a chroma current patch, an additional refinement process can be performed on the scaled K MVs, for example, with a refinement range of [−1, 1].

IV-2-B. Replacement by Larger MVs

In some embodiments, a portion, such as the last quarter, of K luma or chroma candidate MVs can be replaced with a set of predefined larger MVs before the refinement at S830. The predefined larger MVs may be directed to sub-regions of a search window that do not include members of the candidate K MVs on the first list.

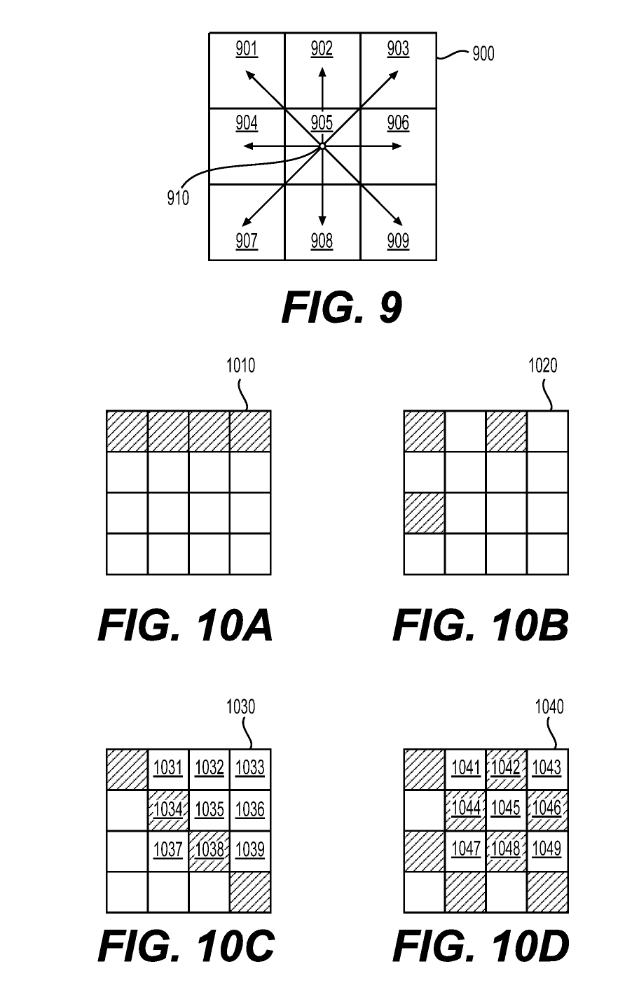

FIG. 9 shows an example of replacing candidate MVs on the first list with larger MVs according to an embodiment of the disclosure. As shown, a search window (e.g., a MSP) 900 can be centered at a position 910 corresponding to a current patch being processed. The search window 900 can be partitioned into 3×3 sub-regions 901-909 each corresponding to one of MVs directing at (−1, 1), (0, 1), (1, 1), (−1, 0), (0, 0), (1, 0), (−1, −1), (0, −1), and (1, −1), respectively (pair values here are used for representing directions of respective MVs). Assuming the K MVs on the first list to be used at S830 are distributed at sub-regions 901-903, then four MVs can be selected from MVs corresponding to sub-regions 904-909, such as MVs at directions of (−1, 0), (0, 0), (1, 0), (−1, −1), (0, −1), and (1, −1), to substitute the last quarter of the K MVs. The resultant new list of K MVs has an increased diversity than the previous first list of K MVs. In some other embodiments of this invention, candidate MVs on the first list are replaced with predefined larger MVs, which are larger than at least part of the candidate MVs on the first list. In some other embodiments of this invention, candidate MVs on the first list are replaced with larger MVs, which are predefined.

IV-2-C. Adding Offset to Scaled Chroma MVs

As described, K MVs of a luma current patch may be scaled and reused for a corresponding chroma current patch. Due to the scaling operations, the resultant chroma MVs may be close to each other resulting in repeated MVs in a list of K MVs. Accordingly, in some embodiments, a repeated MV is transformed by adding a predefined offset to the repeated MV. The predefined offset can be one of eight candidate offsets (−1, 1), (0, 1), (1, 1), (−1, 0), (1, 0), (−1, −1), (0, −1), and (1, −1).

For example, during a scaling process, MVs in a list of K luma MVs can be processed one by one to obtain a list of K chroma MVs. When adding a new scaled MV to the chroma list, if a previously scaled MV the same as the new scaled MV already exists on the chroma list, an offset can be added to the new scaled MV resulting in a transformed MV. If the transformed MV is still included in the chroma list, the step of adding an offset can be repeated. The eight candidate offsets can be tried one by one, until a transformed MV that is not repeated is obtained.

IV-3. Hybrid MV Searching (HMVS) Method Based on a Combination of MSPS and NBFS

A hybrid MV searching (HMVS) method is employed to further improve efficiency of patch group forming processes in various embodiments. In the HMVS method, current patches of a control block can have two portions. A first portion can first be applied with the MSPS method (e.g., the process 600), and subsequently, the second portion can be processed with the NBFS method (e.g., the steps of S820 and S830) based on the results of the first portion. The MSPS method can cover a broad search range in a searching window resulting in a list of K MVs with a high diversity but with a higher computational cost. The NBFS method can obtain a list of K MVs based on previously obtained MV predictors with a lower computational cost. A combination of the MSPS and NBFS can lead to a patch group MV searching method with a high performance and a low computational cost.

FIGS. 10A-10D show some HMVS examples according to some embodiments of the disclosure. In each of FIGS. 10A-10D, each of control blocks 1010-1040 has 16 current patches. The HMVS method is then employed to determine K MVs for each current patch.

In FIG. 10A example, a first row and/or a first column (shaded patches) of a control block 1010 can first be processed with the MSPS method, such as the process 600 in FIG. 6 example. Then, the remaining current patches are processed using the NBFS method, such as the steps S820-S830 in FIG. 8 example. In FIG. 10B example, odd or even number of current patches in the first row and first column (shaded patches) are first processed with the MSPS method, and the remaining current patches are subsequently processed using the NBFS method. In FIG. 10C example, diagonal patches are first processed with the MSPS method, and the remaining current patches are subsequently processed using the NBFS method.

In FIG. 10D example, the current patches in the control block 1040 are divided into or taken as two groups. Members of two groups interleave with each other forming a chessboard pattern. For example, one of the two groups (shaded patches) can first be processed with the MSPS method, and the remaining current patches are subsequently processed using the NBFS method.

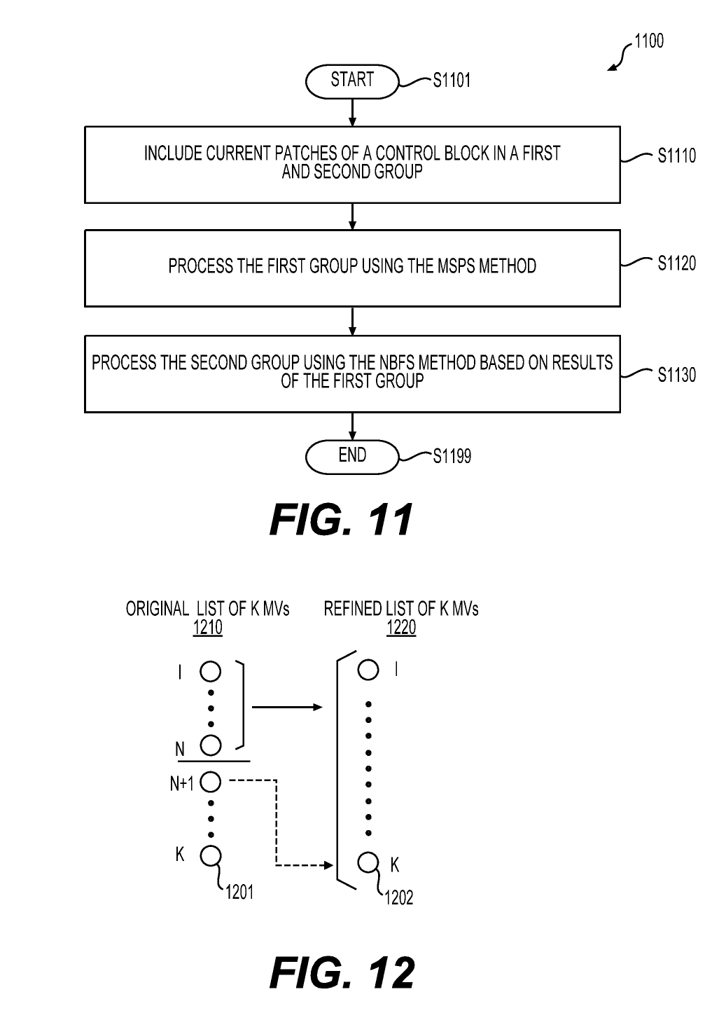

FIG. 11 shows an example process 1100 implementing the HMVS method according to an embodiment of the disclosure. The process 1100 can start from S1101 and proceed to S1110.

At S1110, current patches of a control block are included in a first group and a second group (for example, the current patches of the control block can be divided into or taken as the first group and the second group). At S1120, the first group of current patches can first be processed using the MSPS method. As a result, K MVs corresponding to K most similar reference patches can be determined for each current patch of the first group. In addition, as there is no dependency between current patches processed with the MSPS method, the members of the first group can be processed in parallel.

At S1130, the second group can be processed using the NBFS method based on results of the first patch group obtained at S1120. In one embodiment, the current patches in the second group can be processed in a raster scan order, for example, row by row, from left to right.

In one embodiment, MVs of a current patch of the second group are selected among MVs of four neighboring current patches. For example, the four neighboring current patches can be the top, bottom, left, and right neighboring patches of the current patch if MVs of those four neighboring patches are available. For scenarios that a current patch is adjacent to a border of a control block, one or two neighboring patches may not be available.

As an example, in FIG. 10D, the current patch 1045 has four neighboring patches 1042, 1048, 1044, and 1046 of which MVs are available. In FIG. 10C, the current patch 1035 can have three neighboring patches 1032, 1038, 1034 of which motion vectors are available. Due to the raster scan order, the patch 1036 has not been processed, thus, no MVs of the patch 1036 are available. Particularly, for the FIG. 10D example, where a chessboard-based combination of MSPS and NBFS is adopted, the current patches of the second group can be processed in parallel, because no data dependency exists among members of the second group.

In alternative examples, a set of neighboring current patches of a current patch may be defined differently from the above example for selection of MVs based on the NBFS method. For example, eight neighboring current patches (top, bottom, left, right, top-left, top-right, bottom-left, and bottom-right) of a current patch being processed may be used for providing candidate MVs if respective MVs are available. As an example, in FIG. 10C, the neighboring patches 1031-1034, and 1038 of the current patch 1035 may provide candidate MVs, while the neighboring patches 1036, 1037, and 1039 are to be processed. In FIG. 10D, the neighboring patches 1041-1044, 1046, and 1048 of the current patch 1045 may provide candidate MVs, while the neighboring patches 1047 and 1049 are to be processed. The process 1100 can proceed to S1199 and terminate at S1199.

In one embodiment, the process 1100 is used to process multiple control blocks in parallel. In one embodiment, the process 1100 is used to process different components of a reconstructed picture, such as a luma component, or a chroma component. In one embodiment, the process 1100 is first used to process a luma component, and results of luma current patches are reused for chroma current patches.

While the above process 1100 is described based on control blocks, the HMVS method can be applied to other types of picture regions defined on a reconstructed picture or slice in various video coding standards. Thus, the process 1100 is not limited to control blocks and can be applicable to picture regions partitioned differently from control blocks. In addition, various techniques or method described herein, such as the diversity increasing techniques described in section IV-2, can be used in combination with the HMVS method.

### V. Adaptive Search Range for MSPS MV Searching in Picture Level

As described in section III, the example patch group forming process based on the MSPS process 600 can be performed to process a reconstructed slice. The MSPS process 600 can be based on a predefined search range, such as the search range [−16, 16] in the FIG. 5 example. As an improvement, in some embodiments, multiple search ranges, such as [−16, 16], [−8, 8], and [−4, 4], are tested at encoder side for denoising a reconstructed picture. For example, corresponding to each search range, the denoising process 300 can be performed to process the reconstructed picture to obtain a denoised picture at S360. The example patch group forming process based on the MSPS 600 can be performed to form patch groups for luma or chroma components at S330.

The qualities of the denoised pictures corresponding to different search ranges can subsequently be evaluated. Based on qualities of the denoised pictures, one search range with the best result can be selected among the multiple search ranges. The selected search range can subsequently be signaled to decoder side. For example, an indicator can be encoded in the bit stream 102 to represent the decision of the search range selection. Accordingly, at the encoder side, the selected search range is used for performing a MSPS process.

It is noted that the search range testing technique described herein can be employed at a picture level, a slice level, or other suitable picture region levels. In addition, the search range testing technique is not limited to the example patch group forming process of section III, other reference patch MVs searching techniques or processes based on the MSPS method can also employ the search range testing technique. For example, the basic NBFS, the HMVS, and the like, can also be combined with the search range testing technique in a NL-ALF denoising process.

In various embodiments, various methods are used to evaluate qualities of denoised pictures in order to determine a search range with the best denoising result. In one example, a picture level (or slice level) distortion of luma component, chroma component, or summation of luma and chroma components is evaluated for different search ranges. For example, a denoised picture is compared with an original picture (that is not compressed), to calculate a distortion. The distortion can be a sum of absolute differences (SAD), or a sum of square differences or errors (SSD or SSE), between pixels in the respective two pictures being compared. The search range corresponding to the smallest distortion of the different search ranges can be selected.

In one example, each of the above picture level (or slice level) distortions corresponding to different search ranges is multiplied with a ratio before being evaluated or compared. The ratio can be a constant predefined for each search range. A value of the ratio is correlated with a size of the respective search range. The larger the search range, the larger the ratio value. Under such a configuration, the ratios can be employed to balance quality and cost when evaluating a search range. For example, a larger search range may lead to a better distortion but is associated with a larger computational cost. Thus, the ratio can work as a weight to reflect the respective cost. Accordingly, a probability of selecting a larger search range is decreased, and a larger search range will be selected only when the larger search range has a significantly low distortion.

In one example, instead of employment of a ratio, a bias is added to each picture level distortions corresponding to different testing search ranges. The bias can function similarly as the ratio. For example, the bias can be a predefined constant for each search range. The larger a search range, the larger a value of a bias value.

### VI. Early Termination of a Refinement Process

As described in the MSPS, basic NBFS, or HMVS methods, a first list of K MVs is first obtained, and a refinement process is performed to obtain a refined second list of K MVs. A refinement early termination technique can be employed in some embodiments to save computational cost.

FIG. 12 shows an example of the refinement early termination technique according to an embodiment. An original list 1210 of K MVs and a refined list 1220 of K MVs corresponding to a current patch are shown in FIG. 12. The MVs 1201 or 1202 on each list 1210 and 1220 can be ordered according to similarities (distortions) with respect to the respective current patch. MVs with a higher similarity (smaller distortion) are arranged at higher positions.

During a refinement process, MVs on the list 1210 are processed sequentially from the beginning of the list 1210. When a being processed MV on the list 1210 has a distortion much larger than the last (worst) MV on the list 1210, it means that the being processed MV has much less correlation with the current patch. The MVs following the being processed MV on the first list have little chance of being the final best K MV candidates of the refined list 1220.

As an example, N number of MVs 1201 on the list 1210 has been processed, resulting in the refined list 1220 including K MVs 1202. When processing the (N+1)th MV of the list 1210, a similarity (or distortion) of the (N+1)th MV can first be compared with that of the last (Kth) MV on the list 1220. In one example, when the (N+1) the MV of the list 1210 has a larger distortion (lower similarity) than the last MV of the list 1220, and the difference is larger than a threshold, the refinement process can be early terminated. In other words, the MVs on the list 1210 after the Nth MV will not be processed any more. In various examples, the distortion comparison operation can be started with a MV of the list 1210 after the list 1220 has been filled with K MVs.

### VII. Skipping Non-Essential Fusion Process

As described in the FIG. 4 example, accumulation operations are performed at S420 and S430 where a series of weighted pixel values are added together to obtain an accumulated pixel value of a current patch or a reference patch. This accumulation process at S420 or S430 can also be referred to as a fusion process. In some embodiments, accumulation operations of non-essential weighted pixel values can be skipped to reduce computational cost. For example, when a weight factor w_{i,j} is smaller than a threshold, the respective weighted pixel value can be ignored for obtaining the respective accumulated value.

### VIII. Adaptive Searching Operations for MSPS MV Searching in Patch Level

It is observed that current patches within a small region may have similar characteristics. For example, current patches within a small region can have similar suitable search ranges for forming patch groups. Average distortions of K MVs (or reference patches) of different current patches within a small region can be similar to each other. An average distortion of K MVs or reference patches of a current patch can be calculated by averaging distortions (similarities) of reference patches corresponding to the K MVs. For example, a distortion of a reference patch can be a sum of absolute differences (SAD), or a sum of square differences or errors (SSD or SSE), between pixel values of the reference patch and the respective current patch. Dividing a summation of distortions corresponding to K MVs by K results in the average distortion of K MVs of the current patch.

Based on the above observation, in some embodiments, searching operations can be adapted in patch level during a MSPS based MV searching process (such as the process 600 in the FIG. 6 example). For example, a control block can be partitioned into small regions. Each small region can include a set of current patches. Within such a small region, region-based information indicating characteristics of the respective small region can first be obtained. Subsequently, adaptive searching operations over the current patches within the respective small region can be performed according to the obtained region-based information.

The region-based information reflects local characteristics of a respective small region, thus can be used as a basis to adapt following searching operations performed on current patches within the small region. In various embodiments, different types of local information may be used as the region-based information. For example, information associated with a current patch within the small region, such as a distribution of K MVs of the current patch, an average distortion of the current patch, can be used as region-based information. For example, information associated with the small region, such as K MVs obtained with the whole small region as a patch, can be used as region-based information. In some examples, a combination of different types of local information can be used to adapting following search operations.

An adaptive searching operation can be an MSPS based MV searching process that is adapted in various ways in various examples. For example, a search range, a search pattern (e.g., subsample ratios, subsample sub-region partitions), an MV refinement range, or on-off of a MV refinement process can be adjusted according to region-based information. For example, K MVs obtained with a small region as a patch can be used as initial MVs for current patches within the respective small region, and refinement processes can accordingly be performed for each current patch. Examples of adaptive search operations for MSPS MV searching in patch level are described below.

VIII-1. Search Range Adaptation Based on Similarity of Suitable Search Ranges

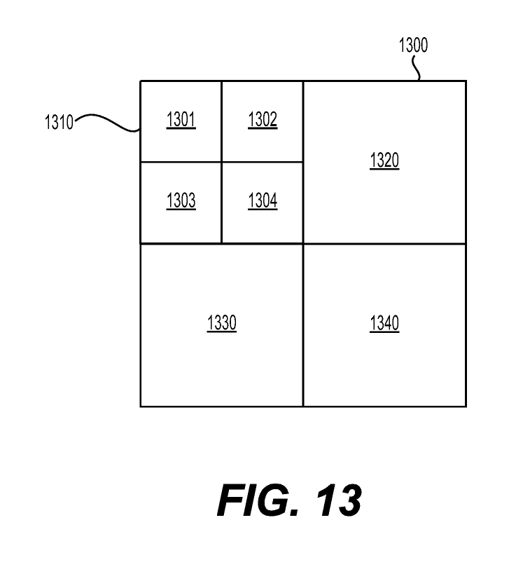

FIG. 13 shows a control block 1300 of size 32×32 pixels that is partitioned into four small regions 1310-1340 each having a size of 16×16 pixels. Within each small region 1310-1340, a search range adaptation technique based on similarity of suitable search ranges can be employed. For example, the region 1310 is partitioned into four current patches 1301-1304. Then, the MSPS method can be employed to form patch groups, or determine K MVs for each current patch 1301-1304.

For the first current patch 1301, a large search range, such as [−16, 16] can be used to perform a MSPS process, resulting a list of K MVs of the current patch 1301 that can be used as region-based information. Based on the region-based information, an adaptive searching operation can be performed. For example, a distribution of the K MVs over the large search range can be analyzed to determine a suitable search range for processing the remaining current patches 1302-1304. The suitable search range can be smaller than the large search range. In one example, the suitable range includes all of MVs on the list of K MVs. In one example, the suitable range includes a percentage of the list of K MVs, such as 50%, 70%, 90%, and the like. By using a smaller search range, computational cost associated with searching of K MVs of the remaining current patches 1302-1304 can be reduced.

For example, when the K MVs are centered around the central position 501 in FIG. 5, a smaller range, for example, [−4, 4] can be used as a suitable search range for the other current patches 1302-1304. Accordingly K MVs of those current patches 1302-1304 can be performed with the determined search range using the MSPS process.

### VIII-2. Search Range Adaptation Based on Similarity of Average Distortions

With reference to FIG. 13, a process employing another search range adaptation technique based on similarity of average distortions of K MVs of different current patches can be performed in the following way. For the first current patch 1301, a large search range, such as [−16, 16] can be used to perform a MSPS process, resulting a first list of K MVs of the current patch 1301. A first average distortion can be calculated for the first list of K MVs. The first average distortion can be used as region-based information. An adaptive searching operation can accordingly be performed. For example, a small search range, such as [−8, 8], can be used for processing the second current patch 1302 by performing the MSPS process, resulting in a second list of K MVs. A second average distortion can be calculated for the second list of K MVs.

Thereafter, an evaluation of the result of the small search range is performed. For example, the second distortion is compared with the first distortion. When a difference between the first and second distortions is smaller than a threshold, the process can proceed to process a next current patch (e.g., the current patch 1303). Otherwise, a second round of MSPS process with a larger search range, such as [−16, 16], can be performed with the second current patch 1302 to obtain a second list of K MVs. Then, the process can proceed to the next current patch.

In one embodiment, the process for processing the second current patch 1302 can be similarly performed on the third current patch 1302. For example, a third average distortion of the third current patch 1303 resulting from a small search range can be compared with the first average distortion for evaluating an effect of the small search range.

In alternative embodiments, an accumulated average distortion can be calculated based on MVs of previously processed current patches. An average distortion of a currently being processed current patch resulting from a small search range is compared with this accumulated average distortion for evaluation a result of using the small search range. For example, when processing the third current patch 1303, a third list of MVs can be obtained corresponding to using the small search range [−8, 8]. A third average distortion can accordingly be calculated. Then, an accumulated average distortion is calculated based on the first list of MVs and the second list of MVs (either from the first or the second round of the above MSPS processes depending on a final determination of the adopted search range). Subsequently, the third average distortion can be compared with the accumulated average distortion to evaluate an effect of the small search range.

In various embodiments, a small region where the patch level search range adaptation techniques are employed can be defined differently than the FIG. 13 example. For example, a small region can be defined independent from control blocks, for example, when control blocks are not used in some examples. Sizes of small regions can vary in different examples.

### VIII-3. MSPS Search Pattern Adaptation

Similar to examples described in sections VIII-1 and VIII-2, a MSPS search pattern can be adapted based on region-information obtained from a first current patch, such as a distribution of the K MVs, or an average distortion.

For example, based on the distribution of the K MVs of the first current patch, a size and position of a sub-region of an MSPS search pattern used for a second current patch (within a same small region as the first current patch) can be adaptively adjusted, for example, to cover all or a preconfigured portion of the K MVs. For example, the K MVs may be concentrated on a small area, and accordingly a sub-region with a higher sub sampling ratio can be positioned around the small area with a suitable size.

For another example, different search pattern configurations can be tested for a second current patch within the same small region based on comparison of average distortions between the first and second current patch. For example, different search pattern configurations may be associated with different computation costs. A search pattern configuration with a lower computation cost can first be tested. Similar to examples in section VIII-2, an optimized search pattern can be determined.

### VIII-4. Refinement Process Range Adaptation

Similar to examples in section VIII-2, the refinement process of the MSPS searching process can be tested based on average distortions. For example, a first set of K MVs of a first current patch within a small region can first be obtained using a MSPS searching process with a refinement process of a first refinement range. Then, a second set of the K MVs of a second current patch within the same small region can be obtained using the MSPS searching process, however, with a second refinement range smaller than the first refinement range. Subsequently, average distortions of the first and second set of K MVs can be compared. If a difference is below a threshold, the searching process can proceed to a third current patch. Otherwise, another round of searching process can be performed for the second current patch with a larger refinement range, such as the first refinement range.

VIII-5. Refinement Process On-Off Adaptation

The refinement process used in the MSPS searching process can be adaptively turned on or turned off based on similarity of average distortions. In one example, similar to the examples in section VIII-2, a first set of K MVs can be obtained for a first current patch within a small region using a MSPS searching process with a certain search range and a refinement process. A second set of K MVs can be obtained for a second current patch within the same small region using the same MSPS searching process with the same search range, however, without a refinement process (turned off). Then, average distortions can be compared between the first and second set of K MVs. If a difference is smaller enough, the refinement process can be skipped for the second current patch to reduce computation cost. Otherwise, the refinement process can be turned on for the second current patch.

In one example, a distribution of a first set of K MVs of a first current patch within a small region is used as the basis to determine on-off of refinement processes of following current patches within the same small region. For example, when the first set of K MVs are scattered over a search window instead of concentration on a small area, the refinement process may be turned on for following current patches within the same small region.

VIII-6. MV Searching for Current Patches Based on K MVs of a Small Region Including the Current Patches

In an embodiment, MV searching for current patches of a small region can be based on region-based information of the small region that is a set of K MVs obtained with the small region treated as a current patch. For example, with the small region treated as a current patch, a MSPS searching process can be performed to determine the set of K MVs, referred to as K region MVs. Then those K region MVs can be used as an initial set of MVs for each current patch within the small region. Based on the initial set of MVs, a refinement process can be performed for each current patch to determine a set of K MVs for each current patch.

### IX. Non-Transitory Computer Readable Medium

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
determining a list of K motion vectors (MVs) for each current patch to form a patch group for the respective current patch that includes the respective current patch and K reference patches corresponding to the K MVs, wherein a reconstructed picture comprises the current patches,
wherein the list of K MVs of a first current patch that is one of the current patches is determined by performing a neighbor-based fast search (NBFS) process that comprises:
selecting K MVs from lists of K MVs of at least one neighboring current patch of the first patch to form a first list of K MVs of the first current patch, and
performing a first refinement process to obtain a second list of K MVs of the first current patch based on the first list of K MVs.

2. The method of claim 1, wherein a first refinement range of the first N MVs on the first list of K MVs is larger than a second refinement range of the last K-N MVs on the first list of K MVs during the first refinement process.

3. The method of claim 1, wherein the NBFS process further comprises:
before performing the first refinement process, replacing a portion of the first list of K MVs with a set of predefined MVs to increase a diversity of the first list of K MVs.

4. The method of claim 1, further comprising:
scaling a determined list of K MVs of one of the current patches of luma component to obtain a list of scaled K MVs of the respective current patch of chroma component;
replacing a portion of the list of scaled K MVs with a set of predefined MVs to increase a diversity of the list of scaled K MVs to obtain a second list of scaled K MVs; and
performing a refinement process based on the second list of scaled K MVs.

5. The method of claim 1, further comprising:
performing a scaling process to scale a determined list of K MVs of one of the current patches of luma component to obtain a list of scaled K MVs of the respective current patch of chroma component,
wherein a repeated scaled MV on the list of scaled K MVs is replaced with a MV having a predefined offset with respect to the repeated scaled MV to increase a diversity of the list of scaled K MVs.

6. The method of claim 1, wherein the reconstructed picture comprises control blocks each including a subset of the current patches, and the method further comprises:
processing the control blocks in parallel to determine the lists of K MVs for the current patches to form the patch groups with a hybrid MV searching (HMVS) process that is performed on each control block, wherein the subset of current patches of a first control block comprises a first group of current patches and a second group of current patches, and the HMVS process comprises:
processing each current patch of the first group with a multi-subsample search pattern based search (MSPS) process, and
processing each current patch of the second group with the NBFS process based on results of the first group.

7. The method of claim 6, wherein the current patches in the first control block are arranged in rows and columns, the top-left current patch in the first control block is included in the first group, the remaining current patches in the first control block are included in the second group, and
the processing each current patch of the second group with the NBFS process comprises:
sequentially processing the current patches of the second group in a raster scan order with the NBFS process,
wherein the at least one neighboring current patch includes a left patch for the current patches in the first row, a top patch for the current patches in the first column, and a top, left, and top-left patches for the other current patches of the second group.

8. The method of claim 6, wherein the current patches in the first control block are arranged in rows and columns, and the first group includes one of:
the current patches in the first row, the first column, or the first row and the first column of the control block;
the odd or even number of current patches in the first row and the first column of the control block;
the current patches on an diagonal of the control block; and
the current patches that interleave with the current patches of the second group forming a chessboard pattern.

9. The method of claim 6, wherein the processing each current patch of the first group with the MSPS process comprises:
processing the current patches of the first group in parallel.

10. The method of claim 6, wherein the current patches in the first control block are arranged in rows and columns, the current patches of the first and second groups interleave with each other forming a chessboard pattern, and
for each current patch of the second group, the at least one neighboring current patch is the current patches of the first group neighboring the respective current patch of the second group.

11. The method of claim 10, wherein the processing each current patch of the second group with the NBFS process comprises:
processing the current patches of the second group in parallel.

12. The method of claim 6, wherein the current patches in the first control block are arranged in rows and columns, the current patches of the first and second groups interleave with each other forming a chessboard pattern, and
for each current patch of the second group, the at least one neighboring current patch includes the current patches of the first group neighboring the respective current patch of the second group, and the current patches of the second group neighboring the respective current patch of the second group that are previously processed.

13. The method of claim 6, wherein a refinement process of the MSPS process or the first refinement process of the NBFS process comprises:
sequentially processing an original list of K MVs of a second current patch to obtain a refined list of K MVs, wherein MVs in refinement ranges of the K MVs on the original list are investigated to select the K MVs on the refined list; and
when it is determined that a being processed MV on the original list has a distortion with respect to the second current patch that is greater than that of a worst MV of K MVs on the refined list, and a difference between the two respective distortions are larger than a threshold, terminating the respective refinement process.

14. The method of claim 1, further comprising:
aggregating weighted pixel values to obtain accumulated pixel values of a current patch or a reference patch of one of the patch groups, wherein one of the weighted pixel values is ignored when a respective weight factor is smaller than a threshold.

15. A method, comprising:
performing multiple rounds of a denoising process based on a multi-subsample search pattern based search (MSPS) process to test multiple search ranges, wherein the reconstructed picture comprises current patches, and each round of the denoising process includes:
determining a list of K motion vectors (MVs) for each current patch to form respective patch groups by performing the MSPS process with one of the multiple search ranges, and
denoising the patch groups to modify pixel values of the patch groups to create a denoised picture including a luma component and/or a chroma component;
evaluating qualities of the created denoised pictures corresponding to different search ranges; and
selecting a search range with a best quality of the denoised pictures from the multiple search ranges based on the evaluation.

16. The method of claim 15, further comprising:
transmitting an indicator indicating the selected search range.

17. The method of claim 15, wherein the evaluating the qualities of the denoised pictures corresponding to different search ranges comprises one of:
comparing distortions of the denoised pictures corresponding to luma component, chroma component, or a summation of luma and chroma components, the distortions of the denoised pictures calculated with respect to a respective original picture;
comparing the distortions of the denoised pictures corresponding to luma component, chroma component, or a summation of luma and chroma components, each of the compared distortions multiplied with a ratio corresponding to the respective search range, wherein the larger the respective search range, the larger the ratio;
comparing the distortions of the denoised pictures corresponding to luma component, chroma component, or a summation of luma and chroma components, each of the compared distortions added with a bias corresponding to the respective search range, wherein the larger the respective search range, the larger the bias.

18. A method, comprising:
providing a region including current patches included in a reconstructed picture;
obtaining region-based information of the region; and
performing an adaptive searching operation that is a first multi-subsample search pattern based search (MSPS) process adapted according to the region-based information of the region.

19. The method of claim 18, wherein,
the obtaining region-based information includes:
searching for K motion vectors (MVs) for a first current patch of the region to form a patch group for the first current patch that includes the first current patch and K reference patches corresponding to the K MVs, the searching based on a second MSPS process with a first search range; and
the performing the adaptive searching operation includes:
determining a second search range based on a distribution of the K MVs over the first search range, the second search range smaller than the first search range, and
searching for K MVs for each of the remaining current patches of the region to form patch groups based on the first MSPS process with the second search range smaller than the first search range.

20. The method of claim 18, wherein,
the obtaining region-based information includes:
searching for a first set of K motion vectors (MVs) for a first current patch of the region to form a first patch group for the first current patch that includes the first current patch and K reference patches corresponding to the first set of K MVs, the searching based on a second MSPS process with a first search range; and
the performing the adaptive searching operation includes:
searching for a second set of K MVs for a second current patch of the region, the searching based on the first MSPS process with a second search range smaller than the first search range,
comparing a first average distortion of the first set of K MVs with respect to the first current patch with a second average distortion of the second set of K MVs with respect to the second current patch, and
when the second average distortion is larger than the first average distortion by a difference larger than a threshold, performing a second round of search to search for K MVs for the second current patch of the region based on the first MSPS process with a third search range larger than the second search range.

21. The method of claim 20, wherein the performing the adaptive searching operation further includes:
searching for a third set of K MVs for a (N+1)th current patch of the region, the searching based on the first MSPS process with the second search range smaller than the first search range;
comparing a third average distortion of the third set of K MVs with respect to the (N+1)th current patch with a fourth average distortion of distortions of MVs of previously processed N current patches of the region; and
when the third average distortion is larger than the fourth average distortion by a difference larger than the threshold, performing a second round of search to search for K MVs for the (N+1)th current patch of the region based on the first MSPS process with the third search range larger than the second search range.

22. The method of claim 18, wherein the region based information includes one of:
a distribution of K MVs of a first current patch of the region corresponding to a patch group of the first current patch,
an average distortion of reference patches of a second current patch of the region, or
a combination of a distribution of K MVs of a third current of the region corresponding to a patch group of the third current patch and an average distortion of reference patches of the third current patch.

23. The method of claim 18, wherein the performing the adaptive searching operation that is the first multi-subsample search pattern based search (MSPS) process adapted according to the region-based information of the region comprises:
adapting a search range, a search pattern, a refinement process range, and/or an on-off of a refinement process of the first MSPS process according to the region-based information of the region.

24. The method of claim 18, wherein,
the obtaining the region-based information of the region comprises:
searching for K region MVs for the region treating the region as a current patch; and
the performing the adaptive searching operation that is the first multi-subsample search pattern based search (MSPS) process adapted according to the region-based information of the region comprises:
performing a refinement process for one of the current patches within the region with the K region MVs as an initial set of MVs.
